(19) United States
(12) Patent Application Publication
(10) Pub. No.: US 2006/0154203 A1
(43) Pub. Date: Jul. 13, 2006

(54) Dental implants having anatomical emergence

(76) Inventor: Silvio Franco Emanuelli, Sanremo (IT)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 11/032,522

(22) Filed: Jan. 10, 2005

(51) Int. Cl. A61C 8/00

(52) U.S. Cl. 433/173

(57) ABSTRACT

Dental implants having anatomical emergence are disclosed. Such an implant may include a post part adapted to receive a dental prosthesis and a root part adapted to be implanted into an socket formed from the extraction of a tooth. The root part may have a tapered portion having a generally round cross-section transverse to the longitudinal axis of the implant, and an anatomical portion having a cross-section transverse to the longitudinal axis that is based on the anatomy of the socket into which the implant is expected to be placed. The anatomical cross-section may be based on a shape associated with either the socket or the tooth. The implant may include one or more retention and stabilizing devices that extend from an exterior surface of the root part. The implant may include a prong that is adapted to move outwardly from an interior portion of the root part when the implant is implanted into the socket. An end of the prong may be adapted to stick into a bone when the implant is implanted into the socket. The implant may include an elongate rod that is movable along the longitudinal axis of the implant. The elongate rod may extend from an exterior of the root part into an interior portion of the root part, and may cause the prong to move outwardly from the interior portion of the root part when the implant is implanted into the socket. The implant may be a press-fit implant or a screw-type implant. The implant may be a one-piece implant, a one-stage implant, or a two-stage implant.

### CROSS-REFERENCE TO RELATED APPLICATIONS

The subject matter disclosed and claimed herein is related to the subject matter disclosed and claimed in U.S. patent application Ser. No. 10/887,053, filed Jul. 8, 2004, entitled “Systems And Methods For Characterizing And Designing Implants For Dental Prostheses.” The disclosure of the above-referenced U.S. patent application is incorporated herein by reference in its entirety.

### FIELD OF THE INVENTION

Generally, the invention relates to dental prostheses. More particularly, the invention relates to dental implants having anatomical emergence. Such implants may include stabilizing devices and may be suitable for implantation into ideal sites.

### BACKGROUND OF THE INVENTION

Biomechanical and aesthetic considerations play a role in the selection of a dental implant for the substitution of a natural abutment. From the biomechanical standpoint, the occlusal surface of a natural tooth is the major recipient of the occlusal loads. How such occlusal loads are distributed on the occlusal surface depends, in part, on the position of the opposing dentition. Typically, occlusal loads are transmitted to the root, then to the ligament, and then to the bone. In an artificial environment, such as where there is an implant-supported crown, for example, occlusal loads may be transmitted directly from the occlusal surface to the post, and through the implant to the bone (typically, the ligament is missing in such an environment).

If the cross-section of the root part of the implant at the emergence is much smaller than that of the corresponding natural abutment, a stress concentration can be anticipated at the emergence. Such a stress concentration may lead to problems such as loosening of components by unscrewing or decementation, for example. Such problems are extensively described in the literature. Clinically, these problems may be solved by diminishing the usable occlusal surface for occlusal contacts. In other words, the prosthetic tooth may receive diminished occlusal forces so as not to create an excessive amount of force.

From an aesthetic standpoint, the appearance of the final crown may depend on the shape of the crown itself and on the relationship between the artificial tooth and the surrounding gingiva. For example, the presence of the papilla has been regarded by some patients and practitioners as a key factor for anterior aesthetics. Also, the presence and quality of the gingival tissue may be determined by the implant positioning in relation to the bone and the overlaying gingiva as well as the relationship with the adjacent teeth. It has been speculated that a minimal distance of 3 mm should be kept between two adjacent implants and a minimal distance of 1.5 mm should be kept between implants and natural teeth in order to predictably obtain the presence of the interdental papilla.

Thus, two conflicting interests may guide the clinician to opposite choices in treatment. That is, biomechanical considerations tend to make larger diameter implants more desirable and aesthetic considerations tend to make smaller diameter implants more desirable.

Additionally, implant shape is typically limited by the round section of the recipient site, universally obtained by the use of cylindrical or conical drills or osteotomes. Furthermore, the popularity of screw type implants reinforces the need for a symmetrical implant and, therefore, a symmetrical implant site. Examples of implants having round cross-sections include cylindrical, conical, and tapered implants. In some instances, however, such as central incisors with highly scalloped hard and soft tissues, lower incisors with narrow mesiodistal dimensions, upper bicuspids, canines, and molars, for example, it may be desirable to insert implants having a shape that does not have a round cross-section.

Accordingly, there is a need for an implant that provides acceptable aesthetics as well as an acceptable biomechanical assembly, the shape of which is not necessarily limited by a round cross-section. It may also be desirable to have the largest cross-section possible at the emergence.

### SUMMARY OF THE INVENTION

A press-fit implant according to the invention may include anatomical emergence, a tapered, press-fit implant body, stabilization features, and a secure lock mechanism. A screw-type implant according to the invention may include a variation in the dimension of the coronal third of the root part in such a way that the section of the implant varies, diminishing in size, from a round cross-section to an anatomical cross-section.

An implant having anatomical emergence may have improved strength compared to a typical implant having round emergence because more metal may be used with anatomical emergence than with round emergence. That is, the cross-section of the implant at the emergence may be larger than that of a typical implant having a round cross-section. Additionally, anatomical emergence may maximize inter-implant distance, which may produce a more desirable aesthetic outcome.

A shape that is more similar to the root anatomy may be desirable because of the increase in popularity of implant placement immediately after the extraction of a failing tooth, or when an ideal site has been reconstructed by augmentation procedures. Such an implant shape may diminish the gap between the implant and the socket. Compared to an implant having a round emergence, an implant having an anatomical emergence may provide better emergence shape, as well as better biomechanics.

Additionally, press-fit implants have been slowly going out of fashion for several reasons. Primary stability and placement precision in cylindrical press-fit implants may be difficult to obtain. Also, press-fit implants may not be suitable for immediate loading because they lack macro-retention features. Improvements for press-fit implants that may overcome these drawbacks are also disclosed.

Primary stability may be obtained and maintained by providing a tapered design (or a stepped or tronco-conical design with a straight wall configuration), thus allowing room for one or more stabilizing devices or a secure lock mechanism. Exact placement may be anticipated due to the precise congruity of the tapered osteotomy with the implants itself, which may be checked using a properly-sized trial implant body.

Thus, a one piece, one-stage, or two-stage press-fit implant may include anatomical emergence along with a body configuration (e.g., tapered, tronco-conical, or stepped) that allows for macro-geographical retention and stabilization devices.

Anatomical emergence may also be obtained in a screw-type implant. Such an implant may be a two-stage, one-stage, or one-piece implant. The root part of the implant may be generally cylindrical or tapered and thus may have a generally round cross-section. The coronal third of the implant may be varied in such a way that the cross-section of the implant at the emergence has certain desirable, anatomical characteristics. For example, the maximum diameter of the axial cross-section may be at the point where the shape starts to change from round to anatomical. Small gaps, which may be created by inserting a smaller implant than the osteotomy, may be compensated for by a minor autogenous bone graft.

### BRIEF DESCRIPTION OF THE DRAWINGS

FIG. 1 depicts a typical anatomical specimen of dentate maxillae.

FIGS. 2A and 2B depict implants placed in a bicuspid socket with round and anatomical emergence, respectively.

FIG. 3 depicts anatomical emergence of a central incisor.

FIG. 4 depicts an example embodiment of a one-piece, press-fit implant for a central incisor.

FIG. 5 depicts an example embodiment of a one-piece, press-fit implant for a molar.

FIGS. 6A-6D depict an example embodiment of an implant according to the invention having a secure lock mechanism.

FIGS. 7A and 7B depict an example embodiment of an osteotomy basket.

FIG. 8 depicts an example embodiment of an osteotomy tip powered by a piezoelectric unit.

FIG. 9 depicts an example embodiment of a precision placement enhancer according to the invention.

FIGS. 10A and 10B depict an example embodiment of a one-piece, screw-type implant having anatomical emergence.

FIGS. 11A and 11B depict an example embodiment of a two-stage, screw-type implant having anatomical emergence.

FIGS. 12A and 12B depict an example embodiment of a two-stage, screw-type implant having an ovoid anatomical emergence.

FIG. 13 depicts an example embodiment of a screw-type implant having a roughly rectangular emergence that may be suitable for molars.

FIGS. 14-16 show tables that provide typical anatomical measurements for teeth and bone.

### DETAILED DESCRIPTION OF ILLUSTRATIVE EMBODIMENTS

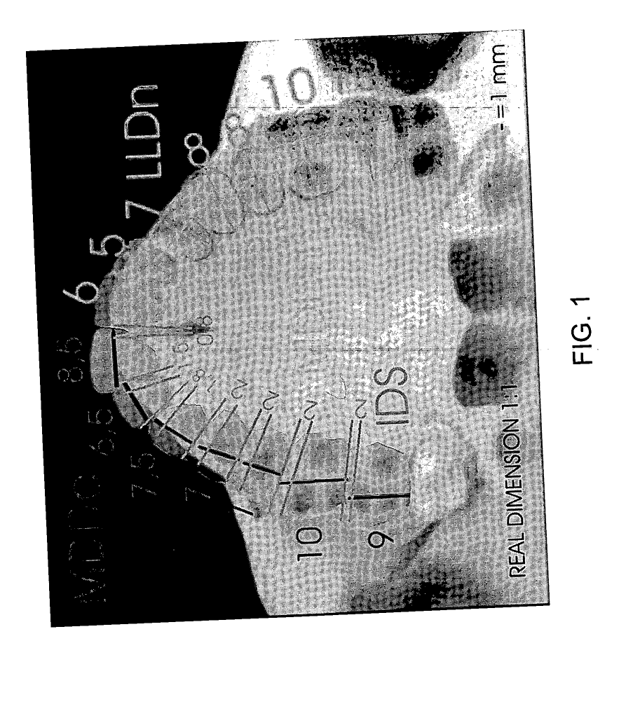

FIG. 1 depicts a typical anatomical specimen of dentate maxillae. As shown, the teeth of both maxillae have been extracted, except for the third molar. Typically, extracted third molars are not replaced, and therefore, are unlikely candidates for ideal rehabilitation. The extracted teeth are depicted in phantom so that the sockets formed by extraction of the teeth may be seen in the figure. The outlines shown on the right maxilla (which is depicted on the left side of FIG. 1) represent the respective shapes of the sockets at the emergence.

Certain measurements, which are described in Ash, Dental Anatomy, Physiology, and Occlusion, 6th ed., 1984, are indicated on the anatomical specimen. Typical values are provided for crown-level mesiodistal diameter MDDc, neck-level mesiodistal diameter MDDn, and neck-level labiolingual diameter LLDn. Typical interdental space (IDS) values are also provided. All values are provided in millimeters. It should be understood that the interdental space IDS may be measured from the anatomy, with an acceptable level of approximation, by subtracting the mesiodistal diameter MDD1 taken at about 2 mm below the neck level. To a good approximation, the mesiodistal diameter MDD1 at about 2 mm below the neck level may be considered the neck-level mesiodistal diameter MDDn.

It should be noted that, in general, MDDn (and, therefore, MDD1) differs from LLDn (and, therefore, from LLD1). Maxillary lateral incisors may be an exception. The difference between the values may be measured. If MDD1 is larger than LLD1, then LLD1, having a positive value, may be subtracted from MDD1. The difference may be represented SHI (i.e., shape indicator). The difference may also be expressed as a percentage. An asymmetry indicator (ASY) may be calculated by dividing SHI by MDD1. The largest dimensional limit of the emergence of an ideal implant may be determined from these values, along with other anatomical values associated with either the tooth or the site, such as bone thickness, for example. Other dimensional and aesthetic considerations may be informed using an algorithm such as described in U.S. patent application Ser. No. 10/887,053.

For example, the total arch length may be the sum of MDDc. The interdental spaces (IDS) may be subtracted from the total arch length. The sum of all the MDD1 may also be obtained. For every tooth, the same proportion may be kept. By increasing the relevance of the IDS, the ideal values of MDD1 relative to the implant may be obtained. The system may vary the measurements as different values of IDS are inputted.

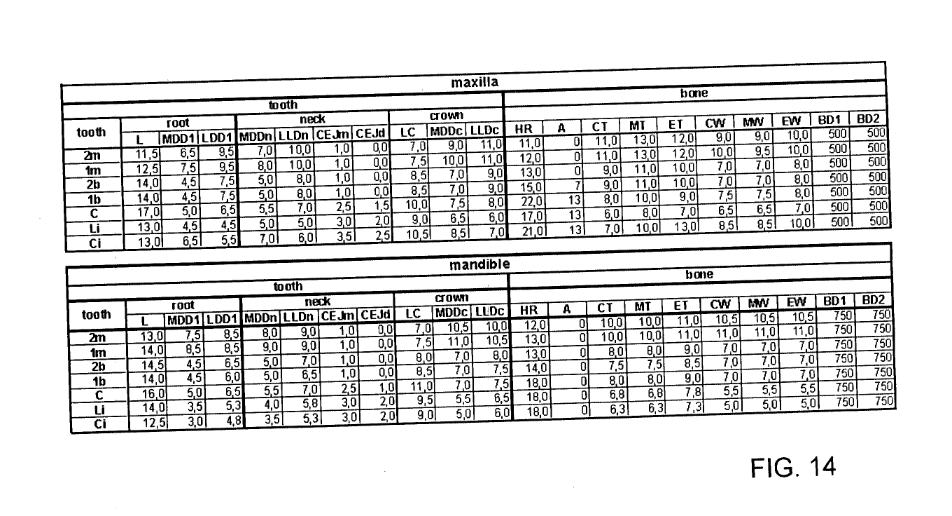

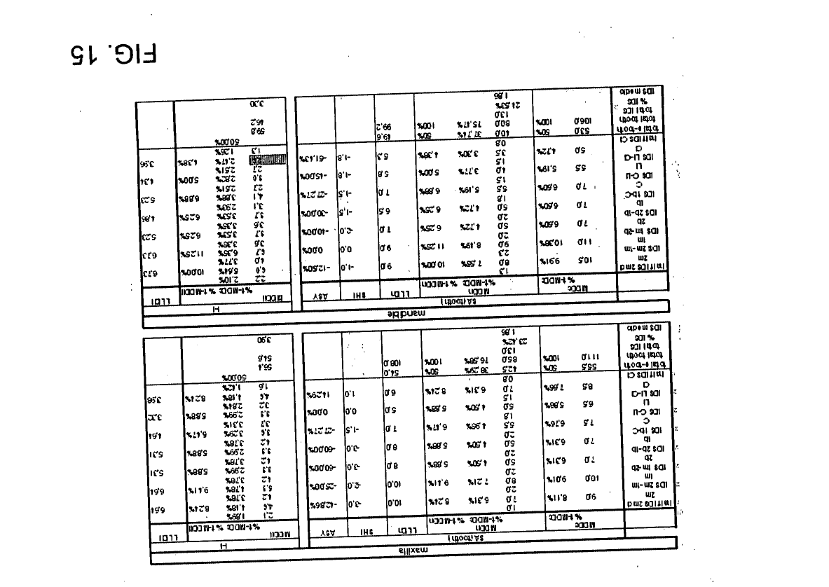

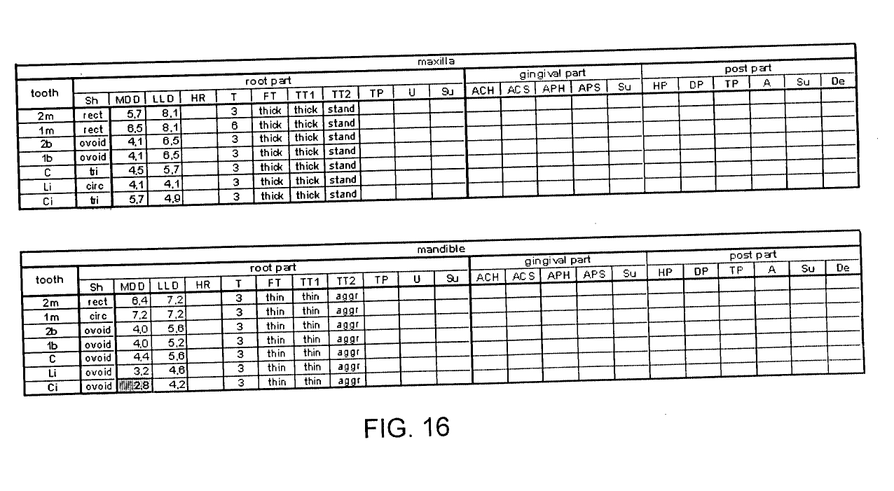

FIGS. 14-16 show tables that provide typical anatomical measurements for teeth and bone. Customized tables may be obtained through accumulation of data from actual anatomical studies, as described in U.S. patent application Ser. No. 10/887,053. As used in the Tables, 2m refers to a second molar, 1m refers to a first molar, 2b refers to a second bicuspid, 1b refers to a first bicuspid, C refers to a canine, Li refers to a lateral incisor, and Ci refers to a central incisor.

Table 1 provides typical anatomical site measurements for maxilla and mandible teeth and bone. For each tooth, data is provided for root, neck, and crown. As used in Table 1, L refers to root length, MDD1 refers to mesiodistal diameter 2 mm apical to the neck, LLD1 refers to labiolingual diameter 2 mm apical to the neck. MDDn refers to mesiodistal diameter at the neck, LLDn refers to labiolingual diameter at the neck, CEJm refers to cej mesial curve, CEJd refers to cej distal curve. LC refers to crown length, MDDc refers to mesiodistal diameter at the crown, LLDc refers to labiolingual diameter at the crown. HR refers to length of anatomical site, A refers to angle between crown and implant axes, CT refers to coronal bone thickness, MT refers to median bone thickness, ET refers to extreme bone thickness, CW refers to coronal bone width, MW refers to median bone width, EW refers to extreme bone width, BD1 refers to bone density at 2 mm, and BD2 refers to bone density 4 mm. Bone density may be measured on a segment going away from the tip of the tooth toward the limit of the bone, and located outside the confines of the tooth approximately 2 mm and 4 mm, respectively, into the recipient bone.

Based on the data provided in Table 1, Table 2 provides shape and asymmetry indicators for example embodiments of implants having anatomical emergence, and Table 3 provides data characteristic of an example embodiment of an ideal implant.

As used in Tables 2 and 3, Sh refers to shape, which may be rectangular, ovoid, circular, or triangular, for example. PF refers to press-fit and SC refers to screw-type. MDD refers to mesiodistal diameter of an ideal implant, LDD refers to labiolingual diameter of an ideal implant. HR refers to height of the root part, T refers to taper, FT refers to fin type (PF), TT1 refers to tack type (PF), TT2 refers to thread type (SC), TP refers to thread pitch (SC), U refers to undersize of final drill, Su refers to surface, which may be machined, SLA, Ti unite, or ceramic bonded. ACH refers to aesthetic collar height, ACS refers to aesthetic collar shape, APH refers to aesthetic plaque height, APS refers to aesthetic plaque shape. HP refers to height of the post part, DP refers to post diameter, TP refers to post taper, A refers to the angle between the post-part axis and the root-part axis. De refers to design.

The values provided for the sockets are expected to be nearly the same as those for the corresponding teeth. Accordingly, it should be understood that a socket may be considered a representation of the emergence of the corresponding tooth. To within a good approximation, measures of the teeth and measures of the sockets may be interchanged. Given the biological differences between natural teeth and dental implants, however, a relatively large inter-implant distance may be desirable. The literature indicates that an inter-implant distance of more than 3 mm may be advisable.

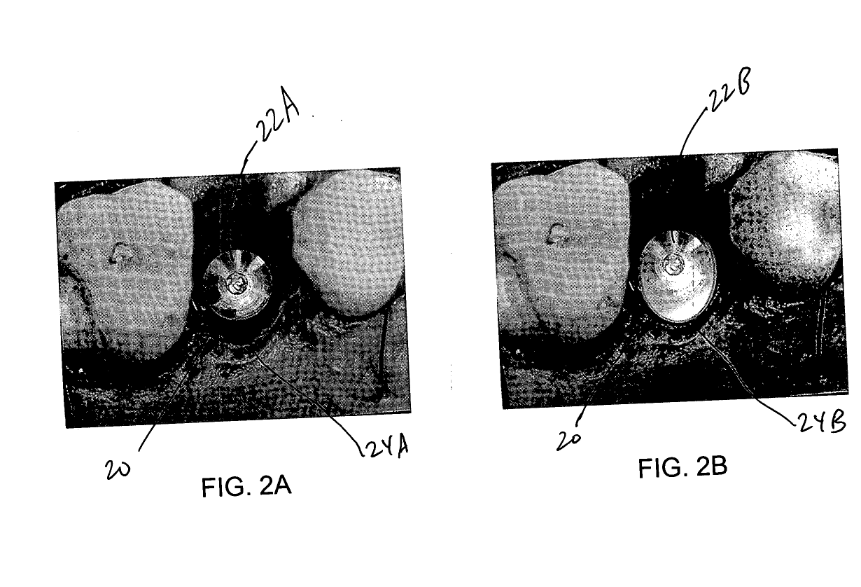

FIGS. 2A and 2B depict implants 22A, 22B placed in a bicuspid socket 20. FIG. 2A depicts the emergence of a typical implant 22A having a round cross-section. Note the size of the gap 24A between the implant 22A and the socket 20. FIG. 2B depicts the emergence of an implant 22B according to the invention with anatomical emergence. Note that the distances between the implant 22B and the adjacent teeth are the same as those depicted in FIG. 2A. The gap 24B between the implant 22B and the socket 20, however, is nearly non-existent. Note also that the cross-section of the implant 22B at the emergence is greater in area than the cross-section of the implant 22A at the emergence. Thus, an implant according to the invention having anatomical emergence may provide for more metal area given the same inter-implant distance. It should be understood that more metal area at the emergence may improve the structural integrity of the implant by better enabling the implant to distribute the occlusal load. It should also be understood that, given the same area of metal at the emergence, an implant having anatomical emergence may provide for increased inter-implant distance as compared to an implant having a round cross-section at the emergence.

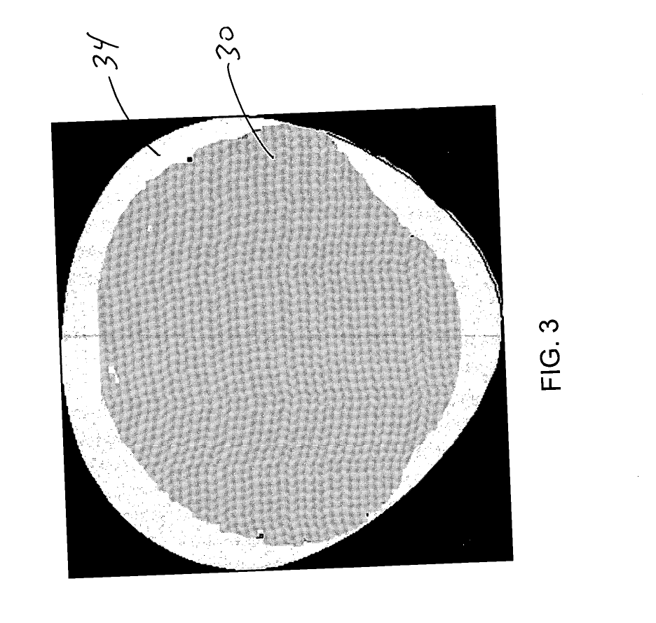

FIG. 3 depicts anatomical emergence of an example central incisor. The cross-section of the root 30 at the emergence (shown in darker gray) may be roughly the same as the cross-section of the socket (not shown) at the same level. The cross-section of an implant 34 according to the invention at the emergence (shown in lighter gray) may be more regular than the cross-section of the root 30 at the same level. The shape of the implant may then be kept as a reference.

Over time, statistical data may be accumulated for a number of such implants, and one or more stock implants designed based on the accumulated data. For example, the actual dimensions of the implant, which may be a custom implant or a stock implant, may be somewhat smaller than the corresponding dimensions of the root to provide for a greater inter-dental implant distance. Actual dimensions may be accumulated using a computer program adapted to generate parametric values to define stock implants that provide for ideal inter-implant distances from other teeth. Systems and methods for characterizing dental implants for ideal cases and using such characterizations to identify parameters defining ideal implants for certain anatomical situations are disclosed in U.S. patent application Ser. No. 10/887,053.

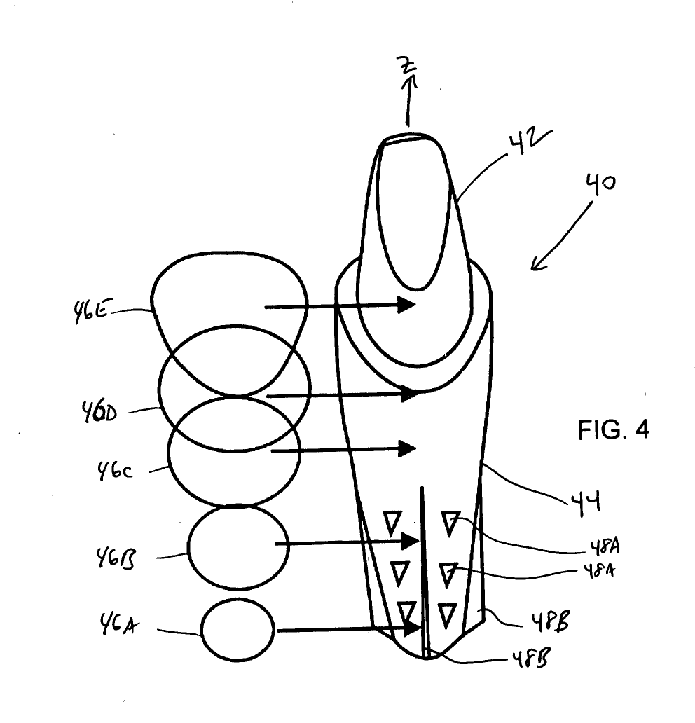

FIG. 4 depicts an example embodiment of a one-piece implant 40 that may be suitable for replacement of a central incisor. As shown, the implant 40 may have a post part 42 and a root part 44. The post part 42 and root part 44 may be made of a titanium alloy, for example, and may be formed in one piece. The implant may also include an optional aesthetic collar (not shown) for aesthetic reasons, should recession of the gingival tissue occur. Examples of such aesthetic collars are disclosed in U.S. patent application Ser. No. 10/887,053.

FIG. 4 also depicts several cross-sectional outlines taken at various points along, and transverse to, the longitudinal axis Z of the implant 40. Note that, as shown, the portion of the implant 40 comprising roughly the lower two-thirds of the root part 44 may be tapered. The cross-sectional outlines 46A and 46B for the tapered portion of the root part 44 may be roughly circular, as shown.

Beginning at about the coronal third of the root part 44, the cross-sectional outlines start to emulate the expected anatomy of the socket. For example, the cross-sectional outlines 46C and 46D may be more elliptical. As shown, the cross-sectional outline 46E of the post part 42 may be irregular in shape. Accordingly, the implant may be formed such that its emergence is based on the cross-sectional outline of the socket into which the implant is to be implanted, or on an expected outline that such a socket is expected to have. As described above, the cross-sectional outline of the socket may be approximated based on the cross-sectional outline of the tooth the prosthesis is designed to replace, or on a shape associated with the tooth (e.g., a “typical” shape for such a tooth based on statistical data accumulated over time for such teeth extracted from ideal sites).

The root part of an implant is an analog of the root of the extracted tooth that is placed into the bone. Typical implants are press-fit or screw-type. It is well-known that the bone around the implant will die a little after placement of the implant into the bone. To avoid micro-motion in order to provide for healing around the implant, it may be desirable for the implant to be held very stable. Such stability may be readily achieved with screw-type implants due to the threads provided in such implants.

With press-fit implants, however, initial stability may be due to the root part having very nearly the same shape as the hole in bone into which the implant is to be placed. In such a scenario, there is some degree of friction between the implant and the hole. Initial stability, however, may not be as good with press-fit implants as it is with screw-type implants. Consequently, it may be desirable to provide one or more stabilizing devices for macro-geographical retention and stabilization of the implant.

As shown in FIG. 4, the root part 44 of the implant 40 may include one or more stabilizing devices such as tacks 48A or fins 48B. Generally, the stabilizing device may be any structure that extends from the exterior surface of the root part such that, when the implant is placed into the socket, the stabilizing device engages the bone, thereby providing stability and retention of the implant. For example, when the implant is placed into the socket, the stabilizing devices may prevent the implant from being fully seated within the socket. By tapping on the post part of the implant, the surgeon can cause the stability devices to engage the bone.

Such stabilizing devices may carve a niche in the bone via which they provide retention (i.e., they tend to prevent the implant from being pulled out of the socket) and stability (i.e., they tend to prevent the implant from rotating within the socket). Fin 48B, for example, may be spaced around the perimeter of the root part 44 of the implant 40, and may extend along a direction that is generally parallel to the longitudinal axis of the implant. The fins 48B may be made of metal, such as a titanium alloy, and may be formed as one-piece with the root part 44 of the implant 40. The fins 48B may function as vertical “threads,” in that, after the implant has been placed into the socket, the fins carve respective niches into the bone and, thus, tend to prevent the implant from rotating within the socket (either about the longitudinal axis or like a pendulum). Accordingly, the fins 48B may have distal edges that are sharp enough to carve into the bone. Tacks 48A may be disposed in any configuration on the surface of the root part 44 such that when the implant is placed into the socket, the tacks 48A engage the bone and tend to prevent the implant from rotating like a pendulum and from being pulled out of the socket). Though the tacks 48A depicted in FIG. 4 are generally triangular in shape, it should be understood that such tacks may be formed in any desired shape, such as rhombi, for example.

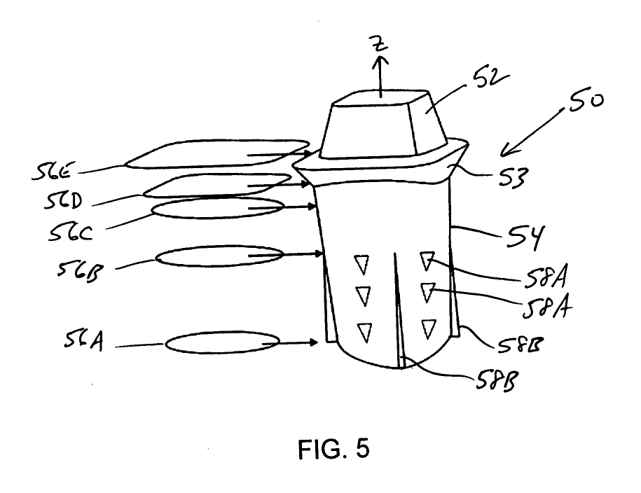

FIG. 5 depicts an example embodiment of a one-piece implant 50 that may be suitable for replacement of a molar. As shown, the implant 50 may have a post part 52 and a root part 54. The post part 52 and root part 54 may be made of a titanium alloy, for example, and may be formed in one piece. The implant may also include an optional aesthetic collar 53 as described above. The collar 53 may be made of a ceramic material. As shown in FIG. 5, the root part 54 of the implant 50 may include one or more stabilizing devices such as tacks 58A or fins 58B, such as described above.

FIG. 5 also depicts several cross-sectional outlines taken at various points along, and transverse to, the longitudinal axis Z of the implant 50. Note that, as shown, the portion of the implant 50 comprising roughly the lower two-thirds of the root part 54 is tapered. The cross-sectional outlines 56A and 56B for the tapered portion of the root part 54 may be roughly circular, as shown.

Beginning at about the coronal third of the root part 54, the cross-sectional outlines start to emulate the expected anatomy of the socket. For example, the cross-sectional outline 56C may be more elliptical. As shown, the cross-sectional outline 46D of the aesthetic collar 53 and the cross-sectional outline 46E of the post part 52 may be irregular in shape, or somewhat like rounded rectangles, as shown. Accordingly, the implant may be formed such that its emergence is based on the cross-sectional outline of the socket into which the implant is to be implanted, or on an expected outline that such a socket is expected to have. As described above, the cross-sectional outline of the socket may be approximated based on the cross-sectional outline of the tooth the prosthesis is designed to replace, or on a shape associated with the tooth (e.g., a “typical” shape for such a tooth based on statistical data accumulated over time for such teeth extracted from ideal sites).

Thus, an implant according to the invention may be formed such that the cross-sectional outlines at and near the emergence are “anatomical.” That is, the implant may be formed having an emergence that resembles the cross-sectional outline of the socket into which the implant is to be implanted. As described above, the cross-sectional outline of the socket may be approximated based on the cross-sectional outline of the root of the tooth the implant is designed to replace.

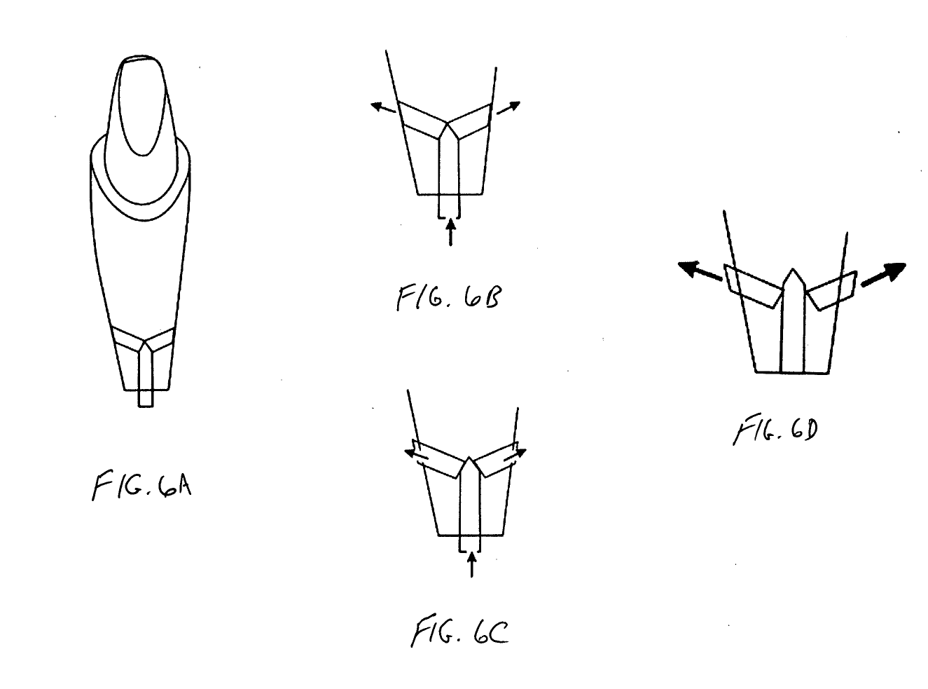

FIG. 6A depicts an example embodiment of an implant 60 having a secure lock mechanism 62 according to the invention. Generally, such a secure lock mechanism 62 may serve as a stability enhancer for the implant 60. As shown, the apical portion 64 of the implant 60 may designed in such a way that, in the final seating, two or more “prongs” 66 may be pushed out from the interior of the implant 60 in such a way as to engage the bone and thus stabilize the implant 60 within the socket. The prongs 66, which may be made of metal, may be pushed out of the implant 60 by an elongate insert, or rod, 68 that is moveable along the longitudinal axis Z of the implant 60. As the rod 68 is moved along the longitudinal axis Z, the rod 68 may force the prongs 66 out of the implant 60 and into the bone. The rod 68 may be moved along the longitudinal axis Z due to the final seating of the implant 60 in the osteotomy.

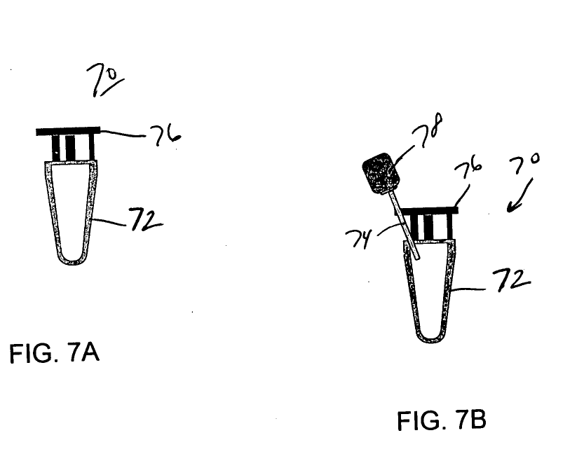

FIGS. 7B-7D depict the secure lock mechanism 62 at various stages during placement of the implant into the socket. FIG. 7B depicts the secure lock mechanism 62 at rest before placement of the implant 60. The rod 68 extends along the longitudinal axis Z of the implant 60 and outside the apical end of the root part of the implant 60. The prongs 66 may be completely inside the root part. The prongs may have ends that cooperate with the interior end of the rod such that, as the rod moves along the longitudinal axis, the prongs are moved out of the root part of the implant and into the bone. Holes may be drilled, or receptacles may be machined, in the root part of the implant for insertion of the rod 68 and the prongs 66.

As shown in FIG. 7C, when the implant is inserted into the socket, the force exerted by the base of the osteotomy on the exterior end of the rod 68 may push the rod 68 in the coronal direction along the longitudinal axis Z. The rod 68 may push the prongs 66 out of the body of the implant 60, and into the lateral walls of the osteotomy. Better function with soft bone may be achieved by enlarging the surface area of the exterior end of the rod 68. Sharpening the exterior edges of the prongs 66 may enable them to work better in cortical bone.

The final seating of the secure lock mechanism is depicted in FIG. 7D. As shown, the osteotomy may push the rod 68 all the way into the implant body. Thus, the prongs 66 may be pushed out of the implant body and into the bone, thereby retaining and stabilizing it in the socket. Of course, it should be understood that the rod and prongs may be designed in any of a number of ways to achieve the same result. For example, helicoidal prongs may be used such that when the rod is pushed into the implant body, prongs that coil around the implant body are moved out of the implant body and into the bone. In another embodiment, a sheet having one or more tacks, or example, may be rolled within the implant body. The rod may move into the rolled sheet and thus push the sheet outward such that the tacks extend out of the implant body and into the bone.

Osteotomy

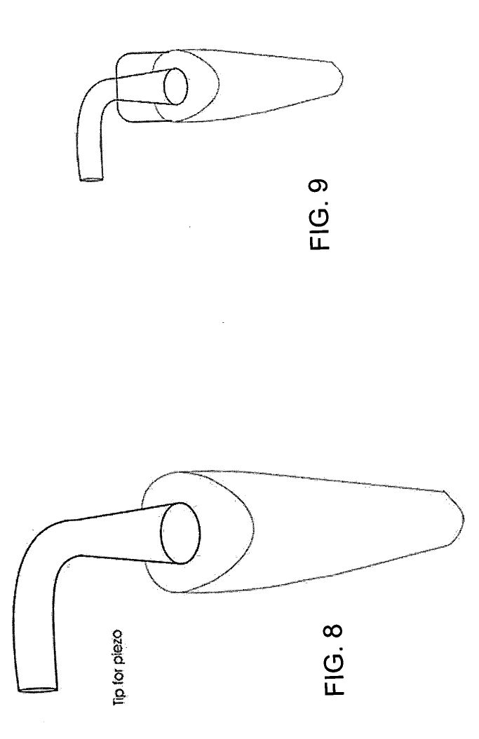

After round-in section osteotomy is obtained in the conventional way with serial drills or other suitable method, a specially designed metal basket may be positioned in the osteotomy so that the surgeon can carve out the socket to match the anatomical portion of the implant. FIGS. 8A and 8B depict an example embodiment of such an osteotomy basket 70. The basket 70 may provide a guide for shaping the portion of the osteotomy that corresponds to the anatomical portion of the implant (e.g., the coronal third of the root part). The basket may be positioned relative to a vestibular reference point (i.e., to the outer part of the bone crest), or in any desirable position. The guide may have a reference point for its correct positioning (vestibular or other).

The body 72 of the basket 70 may be constructed in such a way that the basket replicates the apical two-thirds of the osteotomy, which may be round in cross-section. The basket may be inserted into the round-in section osteotomy.

The outer coronal part of the basket 70 may include a guide 76 that is adapted to lie on the bone. The guide 76 may be made of metal and may represent the outline of the desired osteotomy. The outline may be based on the anatomical emergence of the implant. As shown in FIG. 7B, the surgeon may set a bur 74 mounted on an handpiece 78 on an inner surface of the guide and on an inner surface of the basket body. The surgeon can then run the side-cutting bur 74 around the outline of the guide to form an osteotomy that matches the anatomical emergence of the implant.

The guide may be, for example, about one millimeter thick, to enable the surgeon to visually verify the emergence of the implant in its final positioning. It should be noted that the guide could be of different width (e.g., 1 mm, 1.5 mm, 2 mm, etc.). Thus, the risk of any unwanted proximity to anatomical structures may be reduced or eliminated.

Onto the guide, a precision placement enhancer (e.g., a replica of the final tooth) may be secured to ensure proper placement. The guide, without the basket body, may also be used as a guide for positioning the preliminary drills used in the osteotomy preparation. The coronal third of the basket presents two or more areas without metal where the surgeon can remove bone with a side-cutting bur guided by the metal outer ring and the metal part of the apical thirds of the basket.

Alternatively, as depicted in FIG. 8, a specially shaped osteotomy tip 80 that may be powered by a piezoelectric unit (not shown) can be used to refine the osteotomy. Such refinement may be carried out conventionally, up to the smaller of the mesiodistal and labiolingual diameters. The same shape insert can also be mounted on a handle, thus representing an osteotome for the use in the maxilla or in any other area that presents soft bone.

FIG. 9 depicts an example embodiment of a precision placement enhancer (“PPE”) according to the invention. An autoclavable plastic insert 90 may be mounted on the osteotome. The insert 90 may represent the final crown of the prosthesis to be constructed. The final positioning of the osteotome may be dictated, therefore, by the satisfactory appearance of the position of the insert 90. In the case of multiple implants in a large edentulous area, a vacuum stent on a wax-up of the final position and shape of the teeth may dictate the final position of the PPE and, therefore, the exact placements of the implants.

Screw-Type Implants

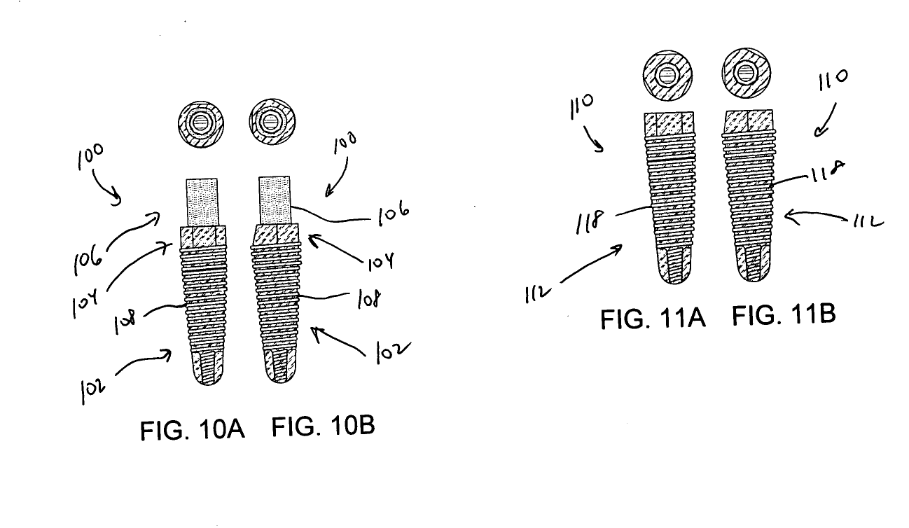

FIGS. 10A and 101B depict side and front views, respectively, of an example embodiment of a screw-type implant having anatomical emergence. Such an embodiment may be suitable for use in replacing maxillary anteriors.

FIGS. 10A and 10B depict an example embodiment of a one-piece, screw-type implant 100 having anatomical emergence. The cross-sectional views are depicted from the top of the implant 100 as shown in FIGS. 10A and 10B, respectively. As shown, the implant 100 may include a root part 102, a gingival part 104, and a post part 106. The root part 102 and post part 106 may be made of a titanium alloy, for example, and may be formed in one piece. The root part 102 may include threads 108 of a certain type and pitch for screwing the root part 102 into the bone. The root part 102 and the post part 106 may each have a degree of taper. The gingival part 104 may include an aesthetic collar (not shown), which may be made of ceramic, for example. An aesthetic collar may be provided for aesthetic reasons should recession of the gingival tissue occur. As shown, the cross-section of the implant at the emergence may be roughly triangular in shape. Note that the body of the implant diminishes in volume gradually.

Though an example embodiment of the invention is described with reference to a one-piece implant for an ideal site, it should be understood that the methods of the invention may be applicable to one-stage and two-stage implants as well.

FIGS. 11A and 11B depict an example embodiment of a two-stage, screw-type implant 110 having anatomical emergence. The cross-sectional views are depicted from the top of the implant 110 as shown in FIGS. 11A and 11B, respectively. As shown, the implant 110 may include a root part 112, which may be made of a titanium alloy, for example. The root part 112 may include threads 118 of a certain type and pitch for screwing the root part 112 into the bone. The root part 112 may have a degree of taper.

Note the outside diameter and the inner triangular shape of the emergence, which may be contained in the outside diameter, as shown. Alternatively, the outlines of the circle and the platform of the emergence could intersect each other. In this case, the diameter of the implant body may be reduced. A moderate countersink may be necessary to accommodate the anatomical platform.

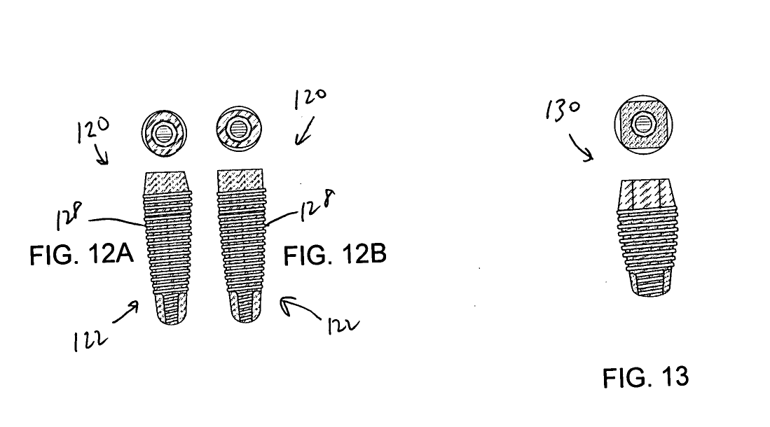

FIGS. 12A and 12B depict an example embodiment of a two-stage, screw-type implant 120 having anatomical emergence. As shown, the implant 120 may have an ovoid emergence. Such an embodiment may be suitable for premolars and mandibular anteriors. FIG. 12A depicts a view from the vestibular or palatal; FIG. 12B depicts a view from the mesial or distal. The cross-sectional views are depicted from the top of the implant 120 as shown in FIGS. 12A and 12B, respectively. As shown, the implant 120 may include a root part 122, which may be made of a titanium alloy, for example. The root part 122 may include threads 128 of a certain type and pitch for screwing the root part 122 into the bone. The root part 122 may have a degree of taper. Note that the platform allows an acceptable inter-implant distance to be maintained.

FIG. 13 depicts an example embodiment of a screw-type implant 130 having a roughly rectangular emergence that may be suitable for molars.

For placement of such screw-type implants, it may be desirable for the osteotomy to be roughly round in cross-section, and as large as the maximum diameter of the emergence. With a countersink bur, it may also be possible to have a minimal oversize of the emergence over the maximum diameter of the osteotomy. After placement, a small gap may remain between the implant and the socket. These areas may be grafted with minimal quantities of autogenous bone collected from the osteotomy site or any other suitable biomaterial.

Because of the anatomical emergence, increased placement precision may be desirable. This may be facilitated by the design of the threads. For example, the threads may have a very short pitch, and may be configured in such a fashion that, for every complete turn of the screw, the displacement in coronal apical direction will be minimal.

Thus there have been described dental implants having anatomical emergence. Though the invention has described herein with reference to one-piece implants, it should be understood that the principles of the invention may be applied to other types of implants, such as one-stage and two-stage implants, for example.

What is claimed:

1. A dental implant, comprising:
a post part adapted to receive a dental prosthesis; and
a root part adapted to be implanted into an oral socket formed from the extraction of a tooth;
wherein at least one of the post part and the root part has an anatomical cross-section transverse to a longitudinal axis of the implant.

2. The dental implant of claim 1, wherein the root part has a tapered portion having a generally round cross-section transverse to the longitudinal axis of the implant.

3. The dental implant of claim 1, wherein the root part has an anatomical portion having an anatomical cross-section transverse to the longitudinal axis, and wherein the anatomical cross-section is based on a shape of a socket into which the implant is expected to be implanted.

4. The dental implant of claim 1, wherein the root part has an anatomical portion having an anatomical cross-section transverse to the longitudinal axis, and wherein the anatomical cross-section is based on a shape of the tooth that has been extracted from the socket.

5. The dental implant of claim 1, wherein the root part has an anatomical portion having an anatomical cross-section transverse to the longitudinal axis, and wherein the anatomical cross-section is based on a shape associated with the tooth that has been extracted from the socket.

6. The dental implant of claim 1, wherein the anatomical cross-section is irregular.

7. The dental implant of claim 1, wherein the anatomical cross-section has a generally oval shape.

8. The dental implant of claim 1, wherein the anatomical cross-section has a generally triangular shape.

9. The dental implant of claim 1, wherein the anatomical cross-section has a generally rectangular shape.

10. The dental implant of claim 1, further comprising a stability device that extends from the root part of the implant, the stability device being adapted to engage a bone upon placement of the implant into the socket so as to prevent the implant from rotating within the socket.

11. The dental implant of claim 1, further comprising a stability device that extends from the root part of the implant, the stability device being adapted to engage a bone upon placement of the implant into the socket so as to retain the implant in the socket.

12. The dental implant of claim 1, further comprising a prong that is adapted to move outwardly from an interior portion of the root part when the implant is implanted into the oral socket.

13. The dental implant of claim 12, wherein an end of the prong is adapted to stick into a bone when the implant is implanted into the oral socket.

14. The dental implant of claim 13, further comprising an elongate rod that is movable along the longitudinal axis of the implant, wherein the elongate rod causes the prong to move outwardly from the interior portion of the root part when the implant is implanted into the oral socket.

15. The dental implant of claim 14, wherein the elongate rod extends from an exterior of the root part into an interior portion of the root part.

16. The dental implant of claim 1, wherein the dental implant is a screw-type implant.

17. The dental implant of claim 1, wherein the dental implant is a press-fit implant.

18. The dental implant of claim 1, wherein the dental implant is a one-piece implant.

19. The dental implant of claim 1, wherein the dental implant is a one-stage implant.

20. The dental implant of claim 1, wherein the dental implant is a two-stage implant.

21. The dental implant of claim 1, wherein the root part has a generally round cross-section transverse to the longitudinal axis of the implant.

22. The dental implant of claim 21, wherein the implant has a cross-sectional area transverse to the longitudinal axis that diminishes in area as it varies from generally round to anatomical along the longitudinal axis.

23. The dental implant of claim 21, wherein the implant has a cross-sectional area transverse to the longitudinal axis that increases in area as it varies from generally round to anatomical along the longitudinal axis.

24. The dental implant of claim 21, wherein an outline of the anatomical cross-section fits within an outline of the generally round cross-section.

25. The dental implant of claim 21, wherein an outline of the anatomical cross-section intersects an outline of the generally round cross-section.

26. A dental implant, comprising:
a post part adapted to receive a dental prosthesis; and
a root part adapted to be implanted into an oral socket formed from the extraction of a tooth;
wherein at least one of the post part and the root part has a cross-sectional outline at an emergence of the implant, the cross-sectional outline having a shape that is based on a shape of a socket into which the implant is expected to be implanted.

27. A dental implant, comprising:
a post part adapted to receive a dental prosthesis;
a root part adapted to be implanted into an oral socket formed from the extraction of a tooth; and
a stability device that extends from the root part of the implant, the stability device being adapted to engage a bone upon placement of the implant into the socket.

28. The dental implant of claim 27, wherein the stability device is adapted to engage the bone so as to prevent the implant from rotating within the socket.

29. The dental implant of claim 27, wherein the stability device is adapted to engage the bone so as to retain the implant in the socket.

30. A dental implant, comprising:
a post part adapted to receive a dental prosthesis;
a root part adapted to be implanted into an oral socket formed from the extraction of a tooth; and
a prong that is adapted to move outwardly from an interior portion of the root part when the implant is implanted into the oral socket.

31. The dental implant of claim 30, wherein an end of the prong is adapted to stick into a bone when the implant is implanted into the oral socket.

32. The dental implant of claim 31, further comprising an elongate rod that is movable along the longitudinal axis of the implant, wherein the elongate rod causes the prong to move outwardly from the interior portion of the root part when the implant is implanted into the oral socket.

33. The dental implant of claim 32, wherein the elongate rod extends from an exterior of the root part into an interior portion of the root part.
